(19) United States
(12) Patent Application Publication
(10) Pub. No.: US 2019/0168459 A1
(43) Pub. Date: Jun. 6, 2019

(54) THREE-DIMENSIONAL SHAPING APPARATUS, CONTROL METHOD OF THREE-DIMENSIONAL SHAPING APPARATUS, AND CONTROL PROGRAM OF THREE-DIMENSIONAL SHAPING APPARATUS

(71) Applicant: KANTATSU CO., LTD., Yaita-shi (JP)

(72) Inventors: Eiji OSHIMA, Tochigi (JP); Kazutaka NOBORIMOTO, Tokyo (JP); Akio SAKUMA, Fukushima (JP)

(21) Appl. No.: 16/146,696

(22) Filed: Sep. 28, 2018

(30) Foreign Application Priority Data
Dec. 4, 2017 (JP) 2017-232905

(51) Int. Cl. B29C 64/393; B29C 64/135; B29C 64/245; B33Y 30/00; B33Y 50/02

(52) U.S. Cl. CPC B29C 64/393; B29C 64/135; B33Y 50/02; B33Y 30/00; B29C 64/245

(57) ABSTRACT

A platform is positioned accurately. There is provided a three-dimensional shaping apparatus for shaping a three-dimensional shaped object, including a material storage, a platform, a moving unit, and a shaping pad. The material storage stores a material of the three-dimensional shaped object. The platform is arranged facing the material storage. The moving unit moves the platform in a vertical direction. The shaping pad on which the three-dimensional shaped object is shaped is provided via an elastic member on a surface, facing the material storage, of the platform.

### CROSS-REFERENCE TO RELATED APPLICATION

This application is based upon and claims the benefit of priority from Japanese patent application No. 2017-232905, filed on Dec. 4, 2017, the disclosure of which is incorporated herein in its entirety by reference.

### BACKGROUND OF THE INVENTION

### Field of the Invention

The present invention relates to a three-dimensional shaping apparatus, a control method of the three-dimensional shaping apparatus, and a control program of the three-dimensional shaping apparatus.

### Description of the Related Art

In the above technical field, patent literature 1 discloses a technique of blocking the lower end of the vertical moving path of a stage by providing, on the inner circumferential surface of a frame portion, a contact portion protruding inward.

[Patent Literature 1] Japanese Patent Laid-Open No. 2013-75389

### SUMMARY OF THE INVENTION

In the technique described in the above literature, however, it is impossible to position a platform accurately.

The present invention enables to provide a technique of solving the above-described problem.

One example aspect of the present invention provides a three-dimensional shaping apparatus for shaping a three-dimensional shaped object, comprising:

a material storage that stores a material of the three-dimensional shaped object;

a platform arranged facing the material storage;

a moving unit that moves the platform in a vertical direction; and

a shaping pad that is provided via an elastic member on a surface, facing the material storage, of the platform, and on which the three-dimensional shaped object is shaped.

Another example aspect of the present invention provides a control method of a three-dimensional shaping apparatus including

a material storage that stores a material of a three-dimensional shaped object,

a platform arranged facing the material storage;

a moving unit that moves the platform in a vertical direction,

a shaping pad that is provided via an elastic member on a surface, facing the material storage, of the platform, and on which the three-dimensional shaped object is shaped, and

a load detector that detects a load applied to the material storage between the platform and the shaping pad,

the method comprising:

causing the moving unit to move the platform in the vertical direction;

detecting the load applied to the material storage; and

controlling, based on the detected load, the movement of the platform by the moving unit.

Still other example aspect of the present invention provides a control program of a three-dimensional shaping apparatus including

a material storage that stores a material of a three-dimensional shaped object,

a platform arranged facing the material storage;

a moving unit that moves the platform in a vertical direction,

a shaping pad that is provided via an elastic member on a surface, facing the material storage, of the platform, and on which the three-dimensional shaped object is shaped, and

a load detector that detects a load applied to the material storage between the platform and the shaping pad,

the program for causing a computer to execute a method, comprising:

causing the moving unit to move the platform in the vertical direction;

detecting the load applied to the material storage; and

controlling, based on the detected load, the movement of the platform by the moving unit.

According to the present invention, it is possible to position a platform accurately.

### BRIEF DESCRIPTION OF THE DRAWINGS

FIG. 1 is a view showing the arrangement of a three-dimensional shaping apparatus according to the first example embodiment of the present invention;

FIG. 2A is a perspective view showing an outline of the arrangement of a three-dimensional shaping apparatus according to the second example embodiment of the present invention;

FIG. 2B is a view showing an outline of the arrangement of the three-dimensional shaping apparatus according to the second example embodiment of the present invention;

FIG. 3A is a view for explaining alignment of a platform by the three-dimensional shaping apparatus according to the second example embodiment of the present invention;

FIG. 3B is a view for explaining the alignment of the platform by the three-dimensional shaping apparatus according to the second example embodiment of the present invention;

FIG. 3C is a view for explaining the alignment of the platform by the three-dimensional shaping apparatus according to the second example embodiment of the present invention;

FIG. 3D is a view for explaining the alignment of the platform by the three-dimensional shaping apparatus according to the second example embodiment of the present invention;

FIG. 3E is a view for explaining the alignment of the platform by the three-dimensional shaping apparatus according to the second example embodiment of the present invention;

FIG. 3F is a view for explaining the alignment of the platform by the three-dimensional shaping apparatus according to the second example embodiment of the present invention;

FIG. 3G is a view for explaining the alignment of the platform by the three-dimensional shaping apparatus according to the second example embodiment of the present invention;

FIG. 3H is a view for explaining the alignment of the platform by the three-dimensional shaping apparatus according to the second example embodiment of the present invention;

FIG. 3I is a view for explaining the alignment of the platform by the three-dimensional shaping apparatus according to the second example embodiment of the present invention;

FIG. 3J is a view for explaining the alignment of the platform by the three-dimensional shaping apparatus according to the second example embodiment of the present invention;

FIG. 4 is a partially enlarged view for explaining the arrangement of a three-dimensional shaping apparatus according to third example embodiment of the present invention; and

FIG. 5 is a flowchart for explaining the operation procedure of the three-dimensional shaping apparatus according to third example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

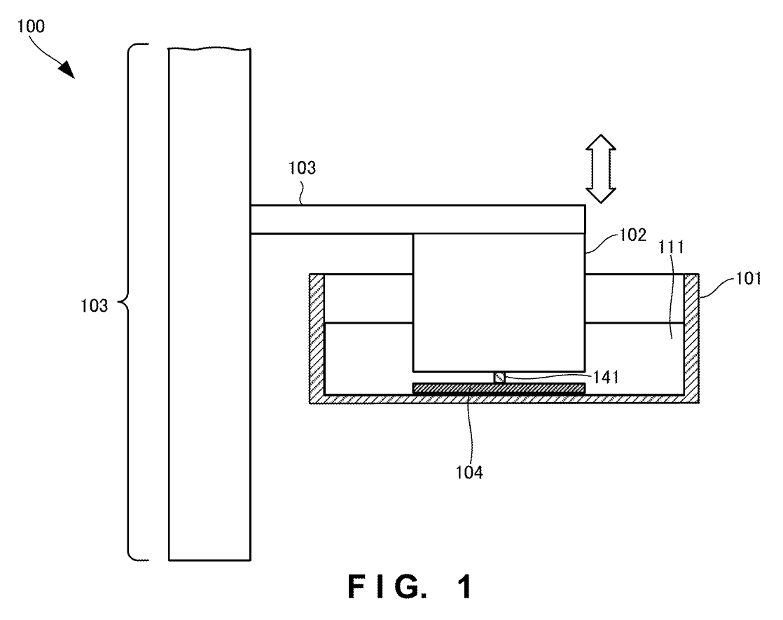

A three-dimensional shaping apparatus 100 according to the first example embodiment of the present invention will be described with reference to FIG. 1. The three-dimensional shaping apparatus 100 is an apparatus that shapes a three-dimensional shaped object by irradiating a material of the three-dimensional shaped object with a light beam.

As shown in FIG. 1, the three-dimensional shaping apparatus 100 includes a material storage 101, a platform 102, a moving unit 103, and a shaping pad 104. The material storage 101 stores a material 111 of a three-dimensional shaped object. The platform 102 is arranged facing the material storage 101. The moving unit 103 moves the platform 102 in the vertical direction. The shaping pad 104 on which the three-dimensional shaped object is shaped is provided via an elastic member 141 on a surface, facing the material storage 101, of the platform 102.

According to this example embodiment, it is possible to position the platform accurately.

### Second Example Embodiment

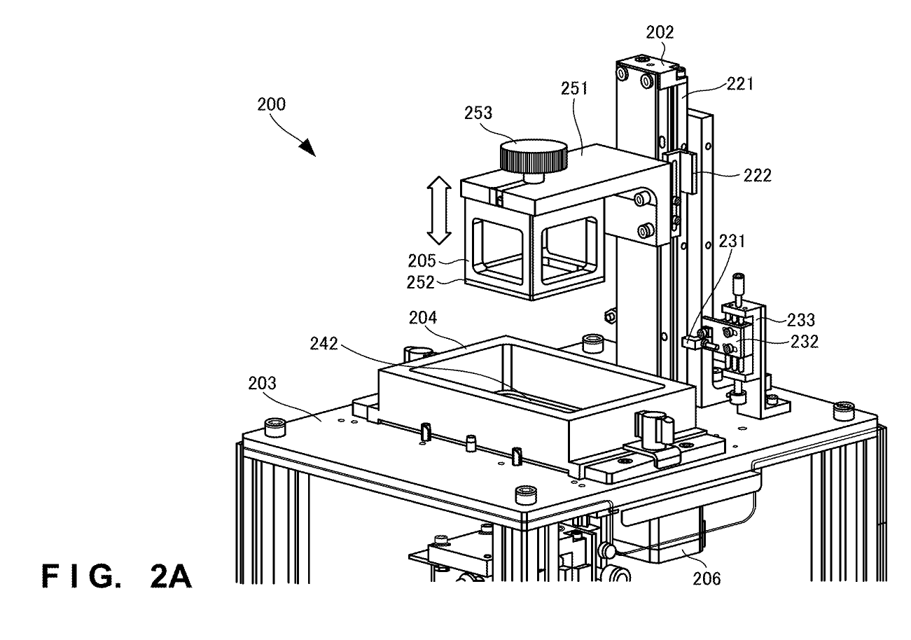

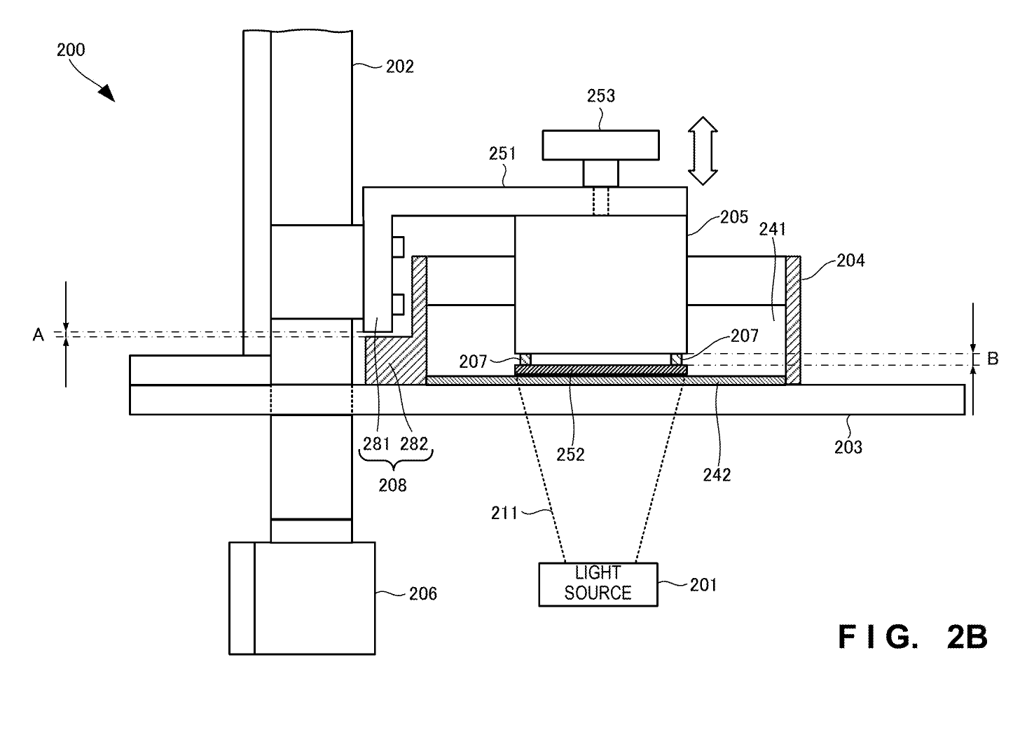

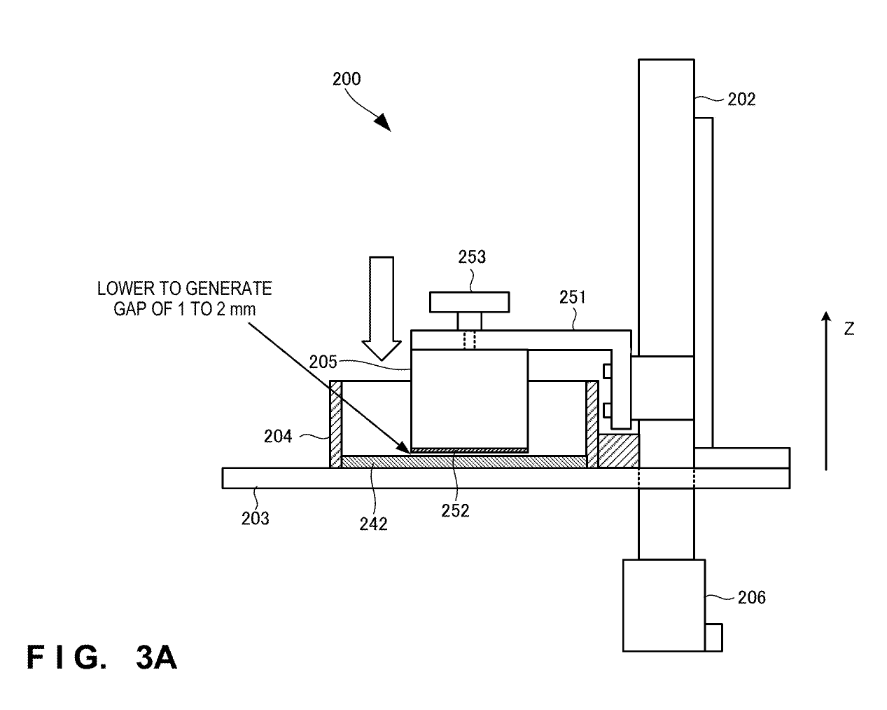

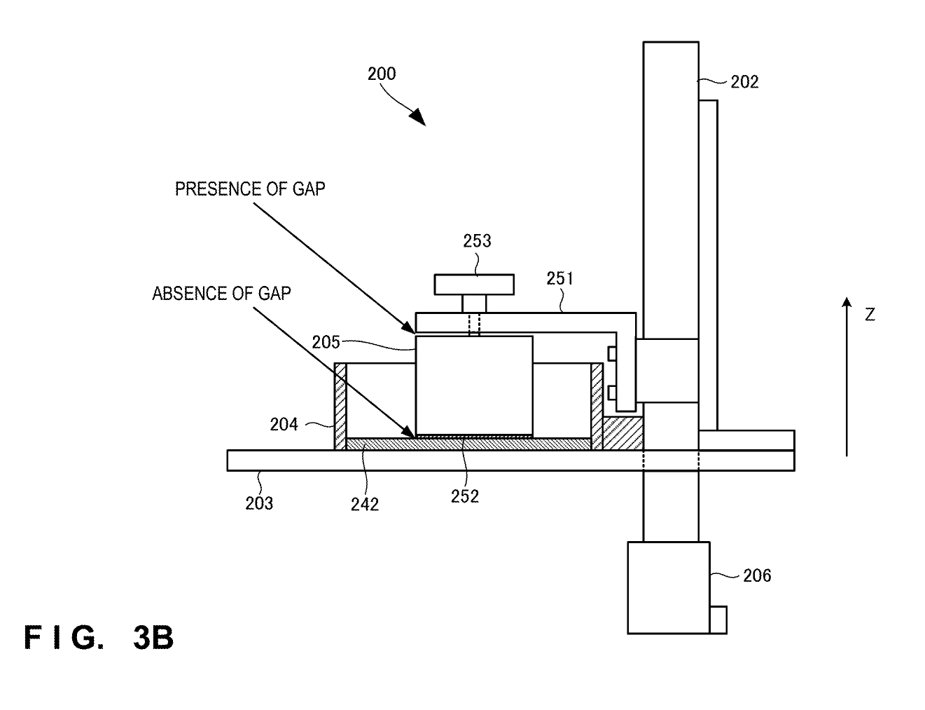

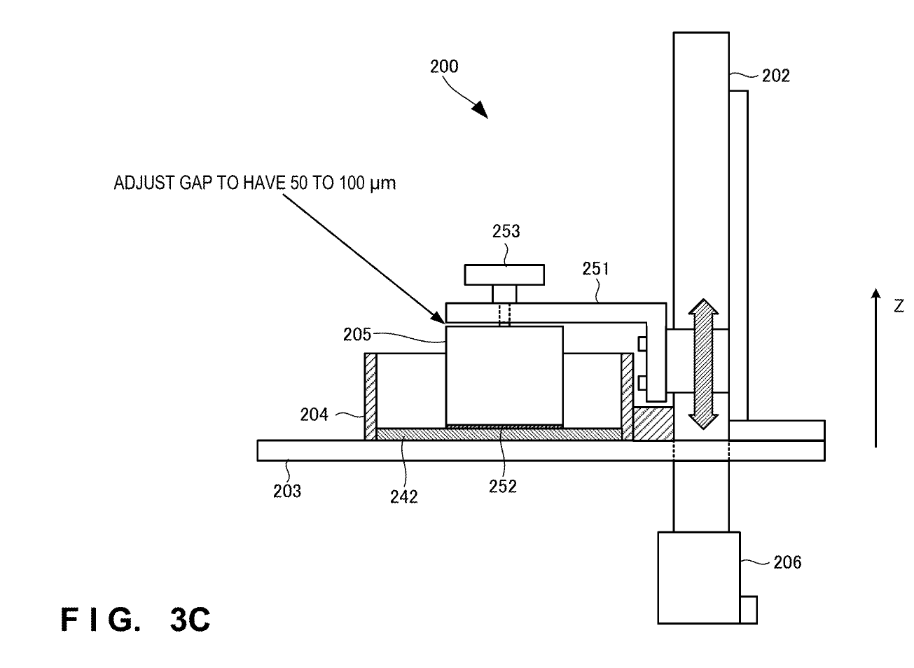

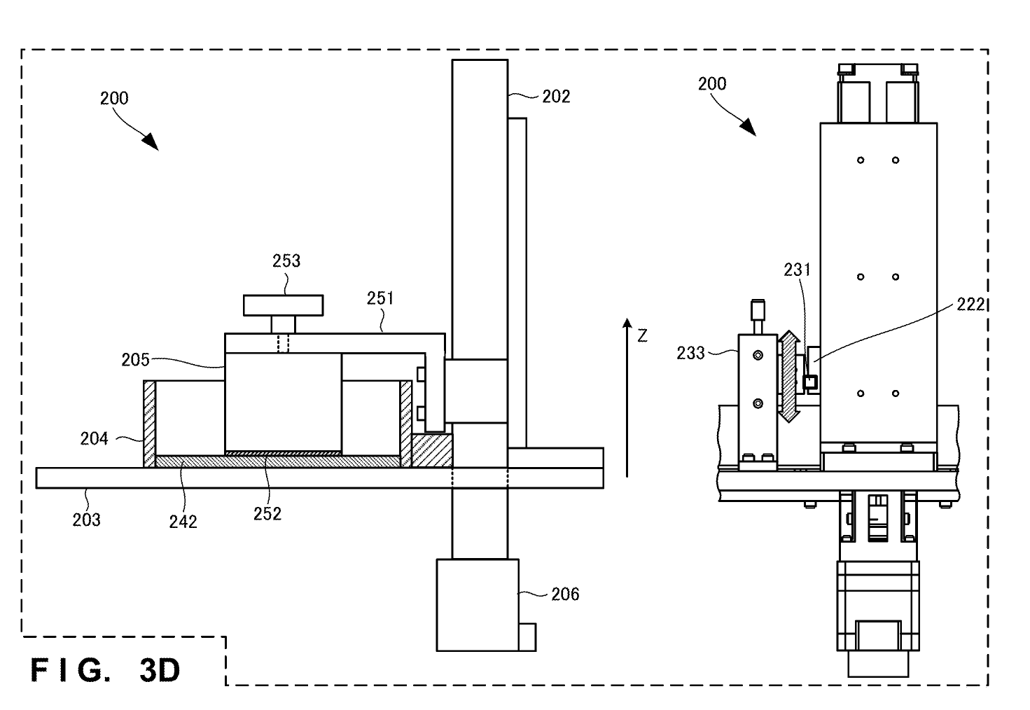

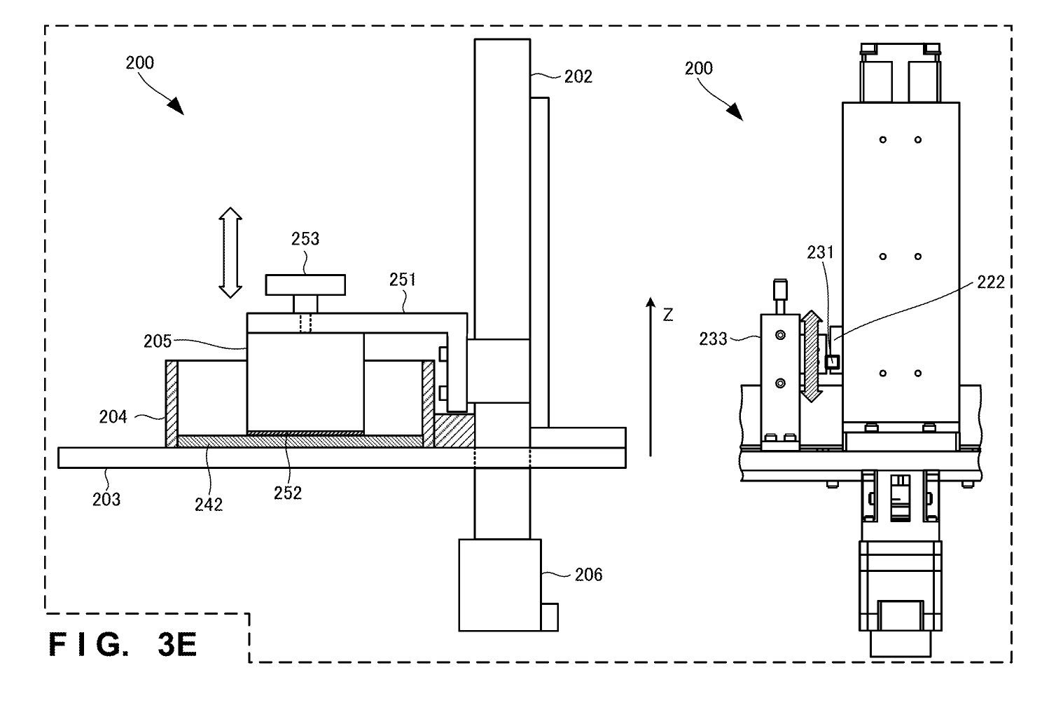

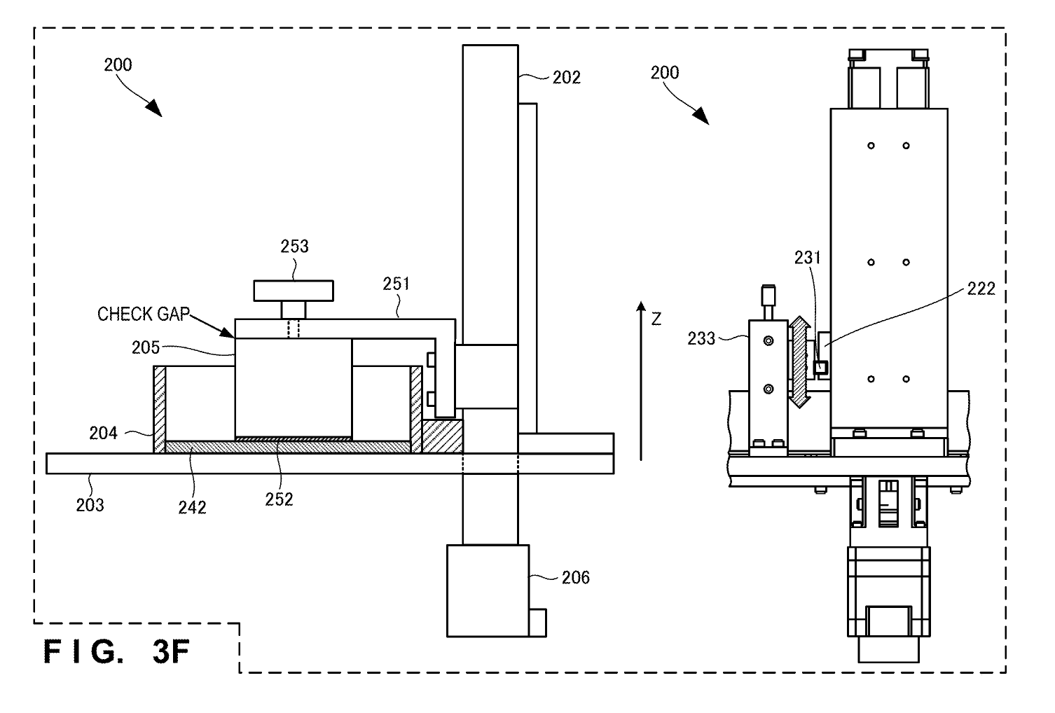

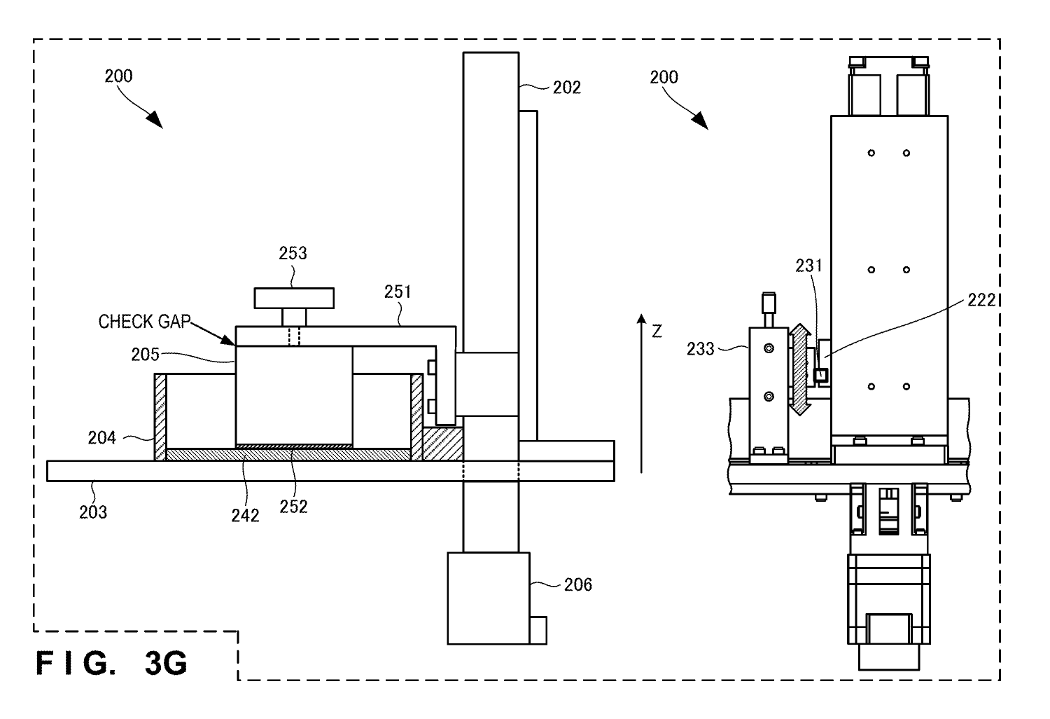

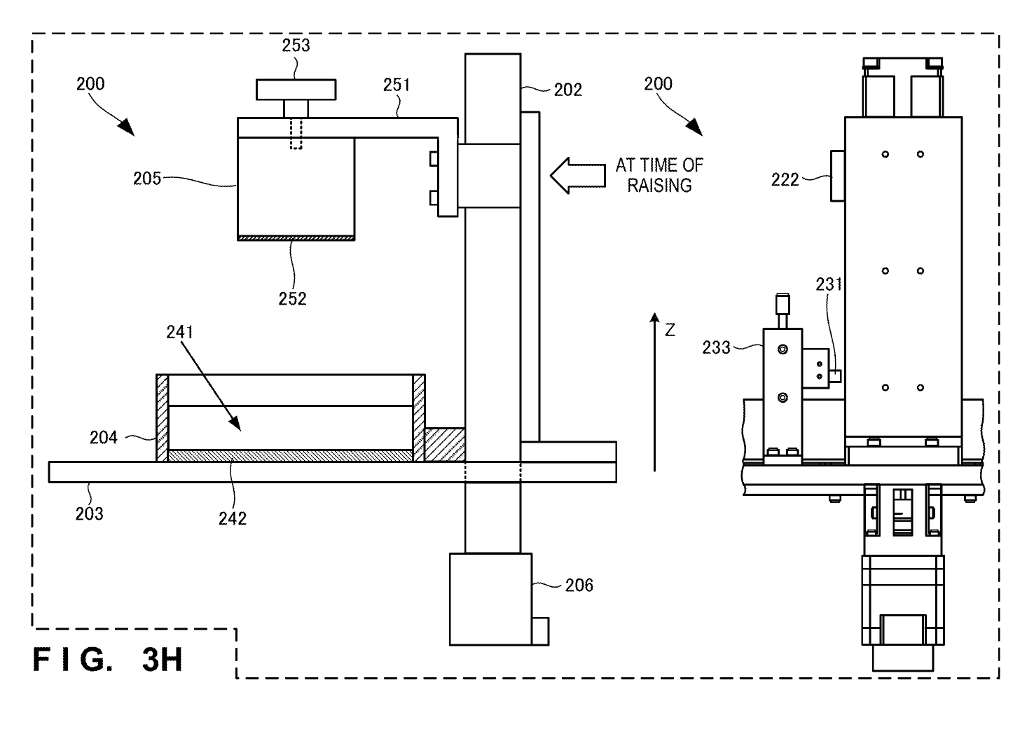

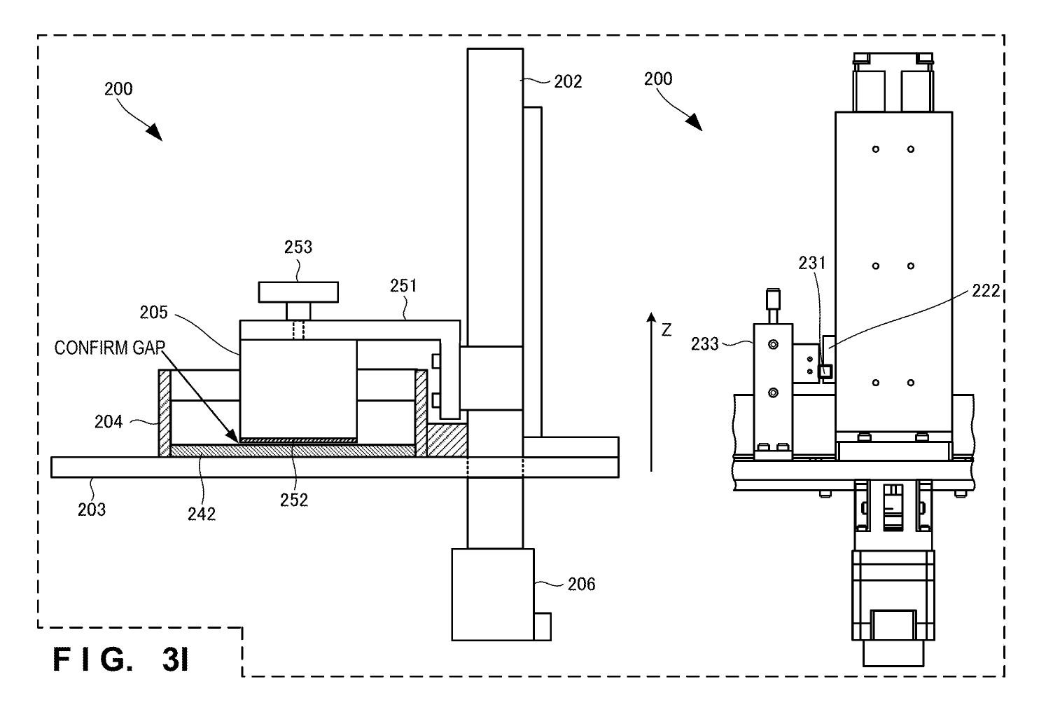

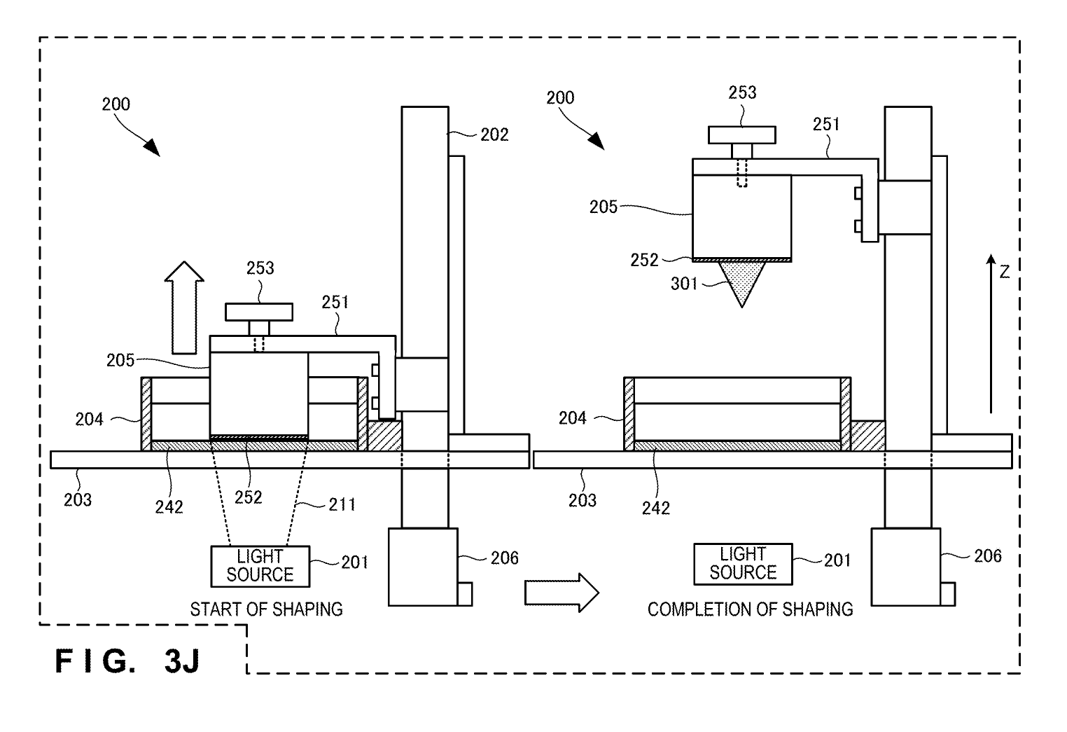

A three-dimensional shaping apparatus according to the second example embodiment of the present invention will be described with reference to FIGS. 2A to 3J.

FIG. 2A is a perspective view showing an outline of the arrangement of the three-dimensional shaping apparatus according to this example embodiment. FIG. 2B is a view showing an outline of the arrangement of the three-dimensional shaping apparatus according to this example embodiment.

A three-dimensional shaping apparatus 200 includes a light source 201, a column 202, a table 203, a material storage 204, a platform 205, a stepping motor 206, elastic members 207, and a regulator 208.

The light source 201 emits a light beam 211 with which a material 241 of a three-dimensional shaped object is irradiated. The material 241 is, for example, a photo-curing resin. The light beam 211 with which the material 241 is irradiated may be any light beam 211 as long as it has a wavelength that can cure the material 241 of the three-dimensional shaped object. The light beam 211 has, for example, a wavelength of 405 nm but may have a wavelength of 200 nm to 400 nm. The present invention is not limited to this.

The table 203 is attached to the column 202. A photosensor 231 is attached to the table 203 via a sensor supporter (sensor bracket) 232. The position of the photosensor 231 is adjusted using a sensor adjustment stage 233.

The material storage (vat) 204 is placed on the table 203. The material 241 of the three-dimensional shaped object is charged and stored in the material storage 204. A bottom surface 242 of the material storage 204 is formed by including a member capable of transmitting the light beam 211. The member capable of transmitting the light beam 211 is represented by, for example, a glass member but the present invention is not limited to this. The entire material storage 204 may be formed by a member capable of transmitting the light beam 211. Note that the material storage 204 may be fixed to a predetermined position on the table 203 by a screw or the like, or may simply be placed on the table 203. A method of placing the material storage 204 on the table 203 is not limited to them.

The platform 205 is attached to a platform support member 251 by a platform mounting screw 253. In addition, the platform 205 is attached to the column 202 via the platform support member 251. The platform 205 can be detached from the platform support member 251 by loosening the platform mounting screw 253. The platform 205 can be fixed to the platform support member 251 by tightening the platform mounting screw 253.

The platform 205 is arranged facing the material storage 204, and the elastic members 207 are provided on a surface, facing the material storage 204, of the platform 205. A shaping pad 252 is provided in the platform 205 via the elastic members 207.

A linear actuator 221 and the stepping motor 206 are provided in the column 202. The platform 205 can be moved in the vertical direction by a moving unit including the platform support member 251, the linear actuator 221, and the stepping motor 206. The position of the platform 205 can be detected using a contact bracket 222 and the photosensor 231.

As the elastic members 207, one or a plurality of members having a small grain shape (cube or rectangular parallelepiped) may be provided or one member having a shape smaller than the area of the surface, facing the shaping pad 252, of the platform 205 may be provided. The present invention is not limited to them. Representative examples of the elastic member 207 are a spring and rubber but the present invention is not limited to them.

The elastic members 207 serve as cushions when the platform 205 lowers, the shaping pad 252 provided in the platform 205 contacts the bottom surface 242 of the material storage 204, and then the platform 205 is pressed downward. That is, although the shaping pad 252 and the bottom surface 242 are in contact with each other, if the platform 205 further lowers, an extra load is applied to the bottom surface 242 made of glass, damaging the bottom surface 242 made of glass.

To prevent damage to the bottom surface 242 even if the platform 205 is pressed downward while the shaping pad 252 and the bottom surface 242 are in contact with each other, the elastic members 207 serve as cushions that absorb the load applied from the platform 205 to the bottom surface 242. Thus, if the position of the platform 205 is erroneously excessively lowered when adjusting the position of the platform 205, the load applied to the bottom surface 242 can be absorbed. That is, if no elastic members 207 are provided, the load is directly applied from the platform 205 to the bottom surface 242, and it is thus impossible to prevent damage to the bottom surface 242 unless the platform 205 is moved correctly.

On the column side of the material storage 204, a mechanical stopper 282 is provided to protrude toward the column. That is, the material storage 204 has not a rectangular box shape but a box shape having a projection. A movement regulator 281 is provided on the lower surface of the end portion, on the column side, of the platform support member 251.

The movement regulator 281 and the mechanical stopper 282 form the regulator 208 that regulates downward movement of the platform 205. That is, if the platform 205 is moved in the vertical direction, the movement regulator 281 also moves in the vertical direction together with the movement of the platform 205. Then, if the movement regulator 281 contacts the mechanical stopper 282, the movement regulator 281 cannot move downward any more, and the platform 205 cannot move downward either.

In this case, as the design dimensions of the three-dimensional shaping apparatus 200, a gap (A) between the movement regulator 281 and the mechanical stopper 282 is made smaller than the height (B) of the elastic members 207 (A<B). Thus, the movement of the platform 205 is restricted by the mechanical stopper 282 in the stroke of the elastic member 207, and no load that is equal to or heavier than a load applied by the elastic members 207 is applied to the bottom surface 242 of the material storage 204.

A procedure of positioning the platform 205 will be described next with reference to FIGS. 3A to 3J. As shown in FIG. 3A, for example, the position of the platform 205 in the vertical direction (plumb direction) is adjusted (Z-axis position adjustment) in a manual mode of software for controlling the three-dimensional shaping apparatus 200. Then, the platform 205 is lowered to a position near the bottom surface 242, made of glass, of the material storage 204. That is, if the platform support member 251 is moved in the vertical direction using the moving unit, the platform 205 also moves in the vertical direction in accordance with the movement of the platform support member 251.

The platform 205 is gradually, finely moved by visual observation by adjusting the moving distance of the platform 205 in the vertical direction (Z-axis direction) by, for example, 10 mm, 1 mm, or 0.1 mm. Then, the platform 205 is moved and lowered to a position at which a gap of 1 to 2 mm is generated between the shaping pad 252 provided on the platform 205 and the bottom surface 242 of the material storage 204.

As shown in FIG. 3B, the shaping pad 252 (shaping pad surface) and the bottom surface 242 are mated with each other by loosening the platform mounting screw 253 of the platform 205. The platform mounting screw 253 is loosened to generate no gap between the shaping pad 252 and the bottom surface 242 and generate a gap between the platform 205 and the platform support member 251. That is, the platform 205 is separated from the platform support member 251 by loosening the platform mounting screw 253, and drops downward, thereby making it possible to mate the shaping pad 252 and the bottom surface 242 with each other.

As shown in FIG. 3C, adjustment is performed so as to generate a gap of 50 to 100 μm between the platform 205 and the platform support member 251. That is, as shown in FIG. 3B, in this state, the platform mounting screw 253 is loosened. Thus, even if the platform support member 251 is moved in the vertical direction using the moving unit, the platform 205 does not move in the vertical direction. Therefore, the platform support member 251 is moved in the vertical direction to generate a gap of 50 to 100 μm between the platform 205 and the platform support member 251.

Note that in this case, if the photosensor 231 operates (an LED (Light Emitting Diode) is turned off) to prevent the position of the platform support member 251 from being lowered, the sensor adjustment stage 233 is used to lower the position of the photosensor 231. In this way, by lowering the position of the photosensor 231, the position of the platform 205 can be further lowered (adjusted to a position at which the LED is turned on).

As shown in the left view of FIG. 3D, after the gap between the platform 205 and the platform support member 251 can be adjusted to have 50 to 100 μm, the platform mounting screw 253 is tightened to fix the platform 205 to the platform support member 251. Then, as shown in the right view of FIG. 3D, after the position of the platform 205 can be fixed, the photosensor 231 is finely adjusted to a position at which the LED is turned off (a position at which the LED is just turned off).

In this state, Z-axis origin return of the software for controlling the three-dimensional shaping apparatus 200 is turned on. That is, this state is set as the reference position of the position of the platform 205. After the platform 205 is raised, the platform is lowered slowly, and stopped at a position where the LED of the photosensor 231 is turned off (see the right view of FIG. 3E).

As shown in the left view of FIG. 3F, the platform mounting screw 253 is loosened, and the gap between the platform 205 and the platform support member 251 is checked. As shown in the right view of FIG. 3F, if the checked gap is large, the position of the photosensor 231 is lowered. If the checked gap is small, the position of the photosensor 231 is raised.

As shown in FIG. 3G, while checking the gap between the platform 205 and the platform support member 251, the procedure shown in FIGS. 3E and 3F is repeated to loosen the platform mounting screw 253 and fix the position of the platform 205, thereby determining the origin setting position. That is, if a slice has 50 μm, the gap between the platform 205 and the platform support member 251 is set to about 50 μm. If the slice has 5 μm, setting is made to generate no gap (a state in which the platform 205 and the platform support member 251 are in tight contact with each other but are not pressed against each other). The slice represents the setting value for the Z-axis at the time of three-dimensional shaping. As the setting value is smaller, shaping is performed more precisely.

As shown in FIG. 3H, the position of the platform 205 is largely raised upward (for example, by 50 mm), and a resin or the like is charged as the material 241 to the material storage 204.

As shown in FIG. 3I, after the material 241 is charged, the position of the platform 205 is lowered to the origin setting position to immerse the shaping pad 252 in the material 241, and the gap between the shaping pad 252 and the bottom surface 242 of the material storage 204 is confirmed. If it is necessary to adjust the gap between the shaping pad 252 and the bottom surface 242 of the material storage 204, the procedure shown in FIGS. 3F, 3G, and 3I is repeated.

As shown in the left view of FIG. 3J, while the platform 205 is raised, the material 241 is irradiated with the light beam 211 from the light source 201 located under the material storage 204, thereby starting shaping of a three-dimensional shaped object 301. As shown in the right view of FIG. 3J, if the shaping of the three-dimensional shaped object 301 ends and another platform 205 is attached to the platform support member 251, the procedure shown in FIG. 3I is performed to confirm and adjust the position of the platform 205. Alignment of the platform 205 has been explained above using FIGS. 3A to 3J.

According to this example embodiment, since the platform 205 can be aligned accurately, it is possible to align the platform 205 and the bottom surface 242 of the material storage 204 correctly. In addition, since the platform 205 and the bottom surface 242 can be aligned correctly, it is possible to shape a high-precision three-dimensional shaped object, for example, a three-dimensional shaped object with an accuracy of the order of several microns.

Furthermore, according to this example embodiment, since the downward movement of the platform 205 is restricted by the action of the regulator 208 at the time of alignment of the platform 205, the bottom surface 242 (glass thereof) of the material storage 204 is never damaged.

### Third Example Embodiment

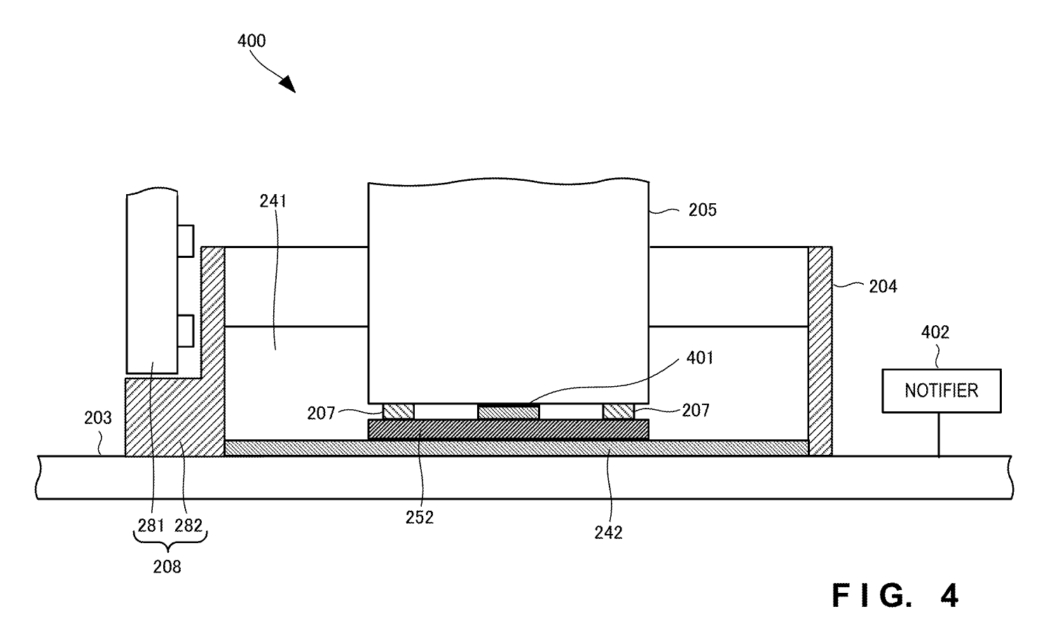

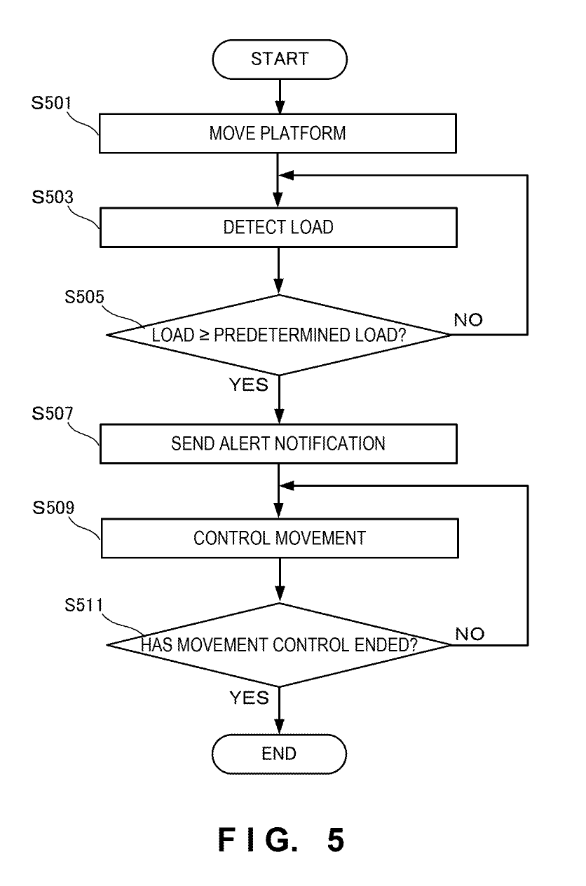

A three-dimensional shaping apparatus according to the third example embodiment of the present invention will be described with reference to FIGS. 4 and 5. FIG. 4 is a partially enlarged view for explaining the arrangement of the three-dimensional shaping apparatus according to this example embodiment. The three-dimensional shaping apparatus according to this example embodiment is different from the above-described second example embodiment in that a load detector is provided. The remaining components and operations are the same as those in the second example embodiment. Hence, the same reference numerals denote the same components and operations, and a detailed description thereof will be omitted.

A three-dimensional shaping apparatus 400 further includes a load detector 401. The load detector 401 detects a load applied from a platform 205 to a bottom surface 242 of a material storage 204. Since the load detector 401 that detects a load is provided, for example, even if the platform 205 moves exceeding a restriction imposed by a regulator 208, the movement of the platform 205 can be detected reliably. Since the excessive movement of the platform 205 can be detected, it is possible to prevent damage to the bottom surface 242 of the material storage 204 more reliably.

The three-dimensional shaping apparatus 400 may also include a notifier 402 that sends an alert notification based on the detection result of the load detector 401. For example, if a load equal to or heavier than a predetermined load is applied to the load detector 401, the notifier 402 sends an alert notification by a sound, light, a vibration, a message, or the like. However, an alert notification method is not limited to them.

FIG. 5 is a flowchart for explaining the operation procedure of the three-dimensional shaping apparatus according to this example embodiment. In step S501, the three-dimensional shaping apparatus 400 causes a moving unit to move the platform 205 in the vertical direction. In step S503, the three-dimensional shaping apparatus 400 detects a load applied to the material storage 204. In step S505, the three-dimensional shaping apparatus 400 determines whether the detected load applied to the material storage 204 is equal to or heavier than the predetermined load. If the load is not equal to or heavier than the predetermined load (NO in step S505), the three-dimensional shaping apparatus 400 continues to detect the load; otherwise (YES in step S505), the three-dimensional shaping apparatus 400 advances to the next step. In step S507, the three-dimensional shaping apparatus 400 sends an alert notification. In step S509, the three-dimensional shaping apparatus 400 controls the movement of the platform 205 by the moving unit in correspondence with the detected load. In step S511, the three-dimensional shaping apparatus 400 determines whether the movement control of the platform 205 has ended. If the movement control of the platform 205 has not ended (NO in step S511), the three-dimensional shaping apparatus 400 continues the movement control of the platform 205; otherwise (YES in step S511), the three-dimensional shaping apparatus 400 ends the operation. Note that the flowchart shown in FIG. 5 is equally applicable in the three-dimensional shaping apparatus 200 described in the second example embodiment.

According to this example embodiment, since the load detector is provided, it is possible to reliably detect the movement of the platform exceeding the restriction imposed by the regulator. Furthermore, since excessive movement of the platform can be detected, it is possible to effectively prevent damage to the bottom surface of the material storage.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

What is claimed is:

1. A three-dimensional shaping apparatus for shaping a three-dimensional shaped object, comprising:
a material storage that stores a material of the three-dimensional shaped object;
a platform arranged facing said material storage;
a moving unit that moves said platform in a vertical direction; and
a shaping pad that is provided via an elastic member on a surface, facing said material storage, of said platform, and on which the three-dimensional shaped object is shaped.

2. The apparatus according to claim 1, further comprising:
a load detector that detects the load applied to said material storage between said platform and said shaping pad; and
a movement controller that controls, based on the detected load, the movement of said platform by said moving unit.

3. The apparatus according to claim 2, further comprising a notifier that sends an alert notification based on a detection result of said load detector.

4. The apparatus according to claim 1, further comprising a regulator that regulates downward movement of said platform.

5. The apparatus according to claim 4, wherein said regulator comprises a mechanical stopper.

6. The apparatus according to claim 1, wherein said material storage includes a member that can transmit a light beam.

7. The apparatus according to claim 6, wherein said member that can transmit the light beam contains glass.

8. A control method of a three-dimensional shaping apparatus including
a material storage that stores a material of a three-dimensional shaped object,
a platform arranged facing the material storage;
a moving unit that moves the platform in a vertical direction,
a shaping pad that is provided via an elastic member on a surface, facing the material storage, of the platform, and on which the three-dimensional shaped object is shaped, and
a load detector that detects a load applied to the material storage between the platform and the shaping pad,
the method comprising:
causing the moving unit to move the platform in the vertical direction;
detecting the load applied to the material storage; and
controlling, based on the detected load, the movement of the platform by the moving unit.

9. A non-transitory computer readable medium storing a control program of a three-dimensional shaping apparatus including
a material storage that stores a material of a three-dimensional shaped object,
a platform arranged facing the material storage;
a moving unit that moves the platform in a vertical direction,
a shaping pad that is provided via an elastic member on a surface, facing the material storage, of the platform, and on which the three-dimensional shaped object is shaped, and
a load detector that detects a load applied to the material storage between the platform and the shaping pad,
the program for causing a computer to execute a method, comprising:
causing the moving unit to move the platform in the vertical direction;
detecting the load applied to the material storage; and
controlling, based on the detected load, the movement of the platform by the moving unit.
